(19) United States
(12) Patent Application Publication
(10) Pub. No.: US 2004/0122766 A1
(43) Pub. Date: Jun. 24, 2004

(54) Method and apparatus for paying bills online

(76) Inventors: Chris Brooks, Sherwood, OR (US); David Brebner, Beaverton, OR (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/327,507

(22) Filed: Dec. 20, 2002

(51) Int. Cl. G06F 17/60

(52) U.S. Cl. 705/40

(57) ABSTRACT

A method and apparatus for paying bills online comprising a plurality of financial institutions exchanging bill payee lists to form a master bill payee list. A first financial institution receiving a bill for its customer, the bill including a bill payee and an amount owed the bill payee by the customer. The first financial institution searching the master bill payee list to determine if the bill payee is on the master bill payee list. Debiting the customer's account if the bill payee is on the master bill payee list, and sending the amount owed to the bill payee's financial institution for depositing in the bill payee's account.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field of the Invention

The invention is related to the field of e-business. In particular, the invention is related to a method and apparatus for paying bills online.

2. Description of the Related Art

Online banking services are commonplace. Many financial institutions permit customers to review their bank account status online, transfer money from one account to another within the financial institution, and to even pay bills online. Bill payment services enable a customer to log on to the financial institution's web-site and to be presented with a bill from a bill payee (i.e., one to whom money is to be paid). Thus, a bill payee may include e.g., a merchant or a business entity. Online bill payment services enable customers to make one-time or recurring bill payments, and to track the customer's payments to bill payees online without writing a paper check.

During setting up of the bill payment service, a customer of the financial institution authenticates at a financial institution's web-site, and either chooses a bill payee from a bill payee list provided by the financial institution, or designates a bill payee if the bill payee is not on the list provided. The customer provides the financial institution with information on the bill e.g., the customer's account number allocated to the customer by the bill payee, the bill payee's name, address, terms of payment, the amount owed on the bill, etc.

When the bill is to be paid, the financial institution credits the account of the bill payee and debits the customer's account for the amount owed on the bill including a service charge if any. However, if the bill payee is not a customer of the financial institution, the financial institution may either send a paper check to the bill payee, or may send the bill payee's information to a third party e.g., a payment processor for processing.

FIG. 1 illustrates a block diagram of conventional bill payment architecture using a payment processor. In the conventional bill payment architecture, a financial institution e.g., financial institution 110A-B receives bill information e.g., via a network (e.g., the Internet) from corresponding customers 105A-B during a bill payment set-up process. Thereafter, the financial institution may receive bills for their customers via the network from the bill payees (120A-D), or the customers may authenticate at the financial institution's web site and enter the bill information as and when a bill is to be paid. If a bill is received for (e.g., customer 105A) and the bill payee (e.g., bill payee 120D) is also a customer of the financial institution, the financial institution 110A credits the bill payee's account and debits the customer's account with the amount owed on the bill. Alternately, financial institution 110A may send the bill (or bill information) along with payment authorization, via the network to a payment processor 150 for processing. However, if the payee (e.g., payee 120A) is not a customer of the financial institution 110A, the financial institution 110A may write and send, via the mail, a paper check to the payee. Alternately, the financial institution 110A may send the bill (or bill information) along with payment authorization, via the network to a payment processor 150 for processing.

The payment processor 150 establishes relationships with bill payees and/or the financial institutions of bill payees. When payment processor 150 receives the bill information along with the payment authorization from financial institution 110A, the payment processor 150 sends the amount owed on the bill, via the network, to the bill payee's financial institution (not shown). In particular, the payment processor 150 authorizes the bill payee's financial institution to credit the bill payee's account the amount owed by customer 105A. Alternately, the payment processor 150 pays the received bill by sending a paper check to bill payee if the payment processor 150 does not have a relationship with the bill payee's financial institution. The payment processor 150 may charge, at least one of, the financial institution 110A-B, the bill payee's financial institution, or the bill payees 120A-C a fee for processing bills.

Sending the bill to a payment processor for processing is inefficient and costly. Because, not only is the bill processing time increased, but also, the payment processor levies a charge for processing the bill.

### BRIEF SUMMARY OF THE DRAWINGS

Example embodiments of the invention are illustrated in the accompanying drawings. The accompanying drawings, however, do not limit the scope of the invention. Similar references in the drawings indicate similar elements.

FIG. 1 illustrates a block diagram of conventional bill payment architecture using a payment processor.

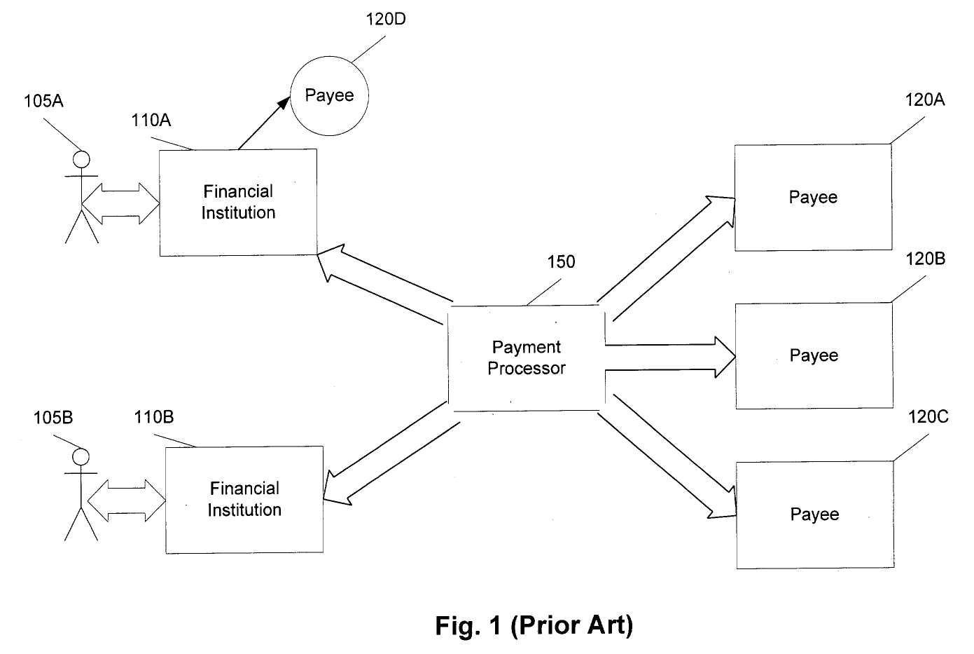

FIG. 2 illustrates a block diagram of bill payment architecture according to one embodiment of the invention.

FIG. 3 illustrates a flow diagram for paying bills according to one embodiment of the invention.

FIG. 4 illustrates an apparatus for paying bills online according to one embodiment of the invention.

FIG. 5 illustrates a bill payment module according to one embodiment of the invention.

### DETAILED DESCRIPTION

Described is a method and apparatus for paying bills online. The method for paying bills online comprises a first financial institution sending via a network a first bill payee list to a second financial institution, and receiving via the network from the second financial institution a second bill payee list, wherein the first and the second bill payee list comprises customers of the financial institutions. The first financial institution receiving a bill for its customer, the bill including a bill payee and an amount owed the bill payee by the customer. The first financial institution searching the first and the second bill payee lists to determine if the bill payee is on at least one of the first bill payee list and the second bill payee list. Debiting the customer's account if the bill payee is on at least one of the first bill payee list and the second bill payee list, and sending the amount owed to the bill payee's financial institution for depositing in the bill payee's account.

If the bill payee is the first financial institution or is a customer of the first financial institution, the bill payee's account at the first financial institution is credited. If the bill payee is on the second bill payee list, the first financial institution requests an authorization from the second financial institution to pay the bill. On receiving the authorization from the second financial institution, the first financial institution debits its customer's account and credits the second financial institution's account. Alternately, the first financial institution may send the bill payment and credit the account of the second financial institution without seeking an authorization from the second financial institution. The second financial institution then credits the account of the payee and may provide the payee with e.g., an invoice number of the bill. The second financial institution credits payees of the first financial institution via the method illustrated above. In one embodiment of the invention, the first financial institution or the second financial institution settles the net debt owed to the other via a periodic transfer of funds.

In one embodiment of the invention a financial institution or an application service provider (ASP) may receive bill payee lists from a plurality of financial institutions. The financial institution or the ASP may compile a master bill payee list that includes billing information about payees and their corresponding financial institutions (i.e., financial institutions that service the account of the payee). The financial institution or the ASP compiling the master bill payee list sends the master bill payee list via a network e.g., the Internet to the plurality of financial institutions. Each of the plurality of financial institutions on receiving a bill for its customer searches the master bill payee list and pays the bills owed by their customers using the methods illustrated above.

In the following description numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid obscuring the present invention.

The invention may utilize a distributed computing environment. In a distributed computing environment, program modules may be physically located in different local and remote memory storage devices. For example, the program code for compiling the master bill payee list may be stored on one server, and the program code for the bill payment program, may be stored on a different server. Execution of the program modules may occur locally in a stand-alone manner on the same server, or evaluation of the program modules may occur remotely in a client/server manner. Examples of such distributed computing environments include local area networks, enterprise-wide computer networks, and the global Internet. Lastly, repeated usage of the phrase “in one embodiment” does not necessarily refer to the same embodiment, although it may.

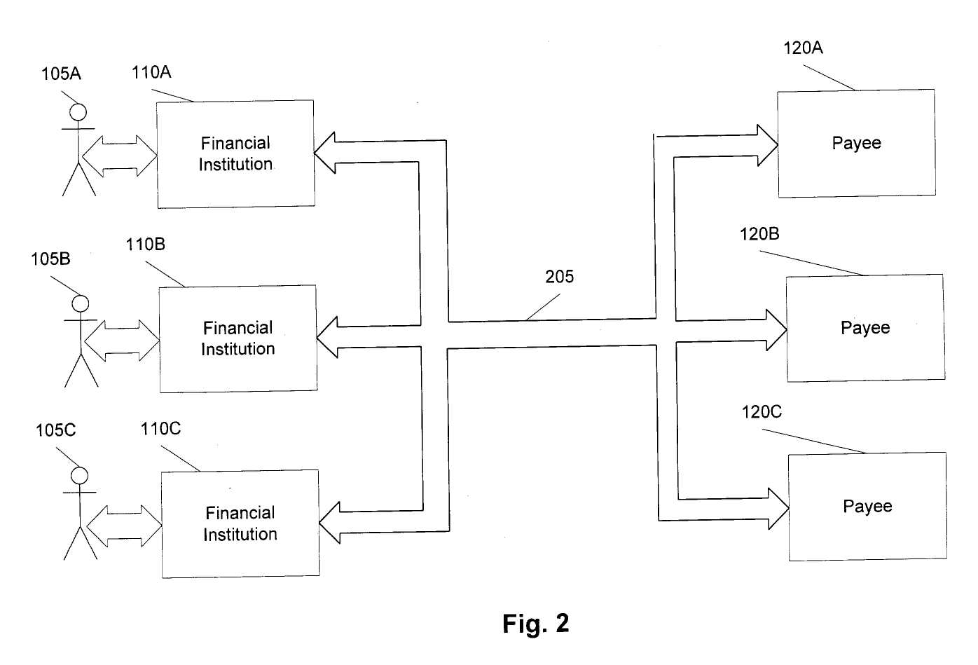

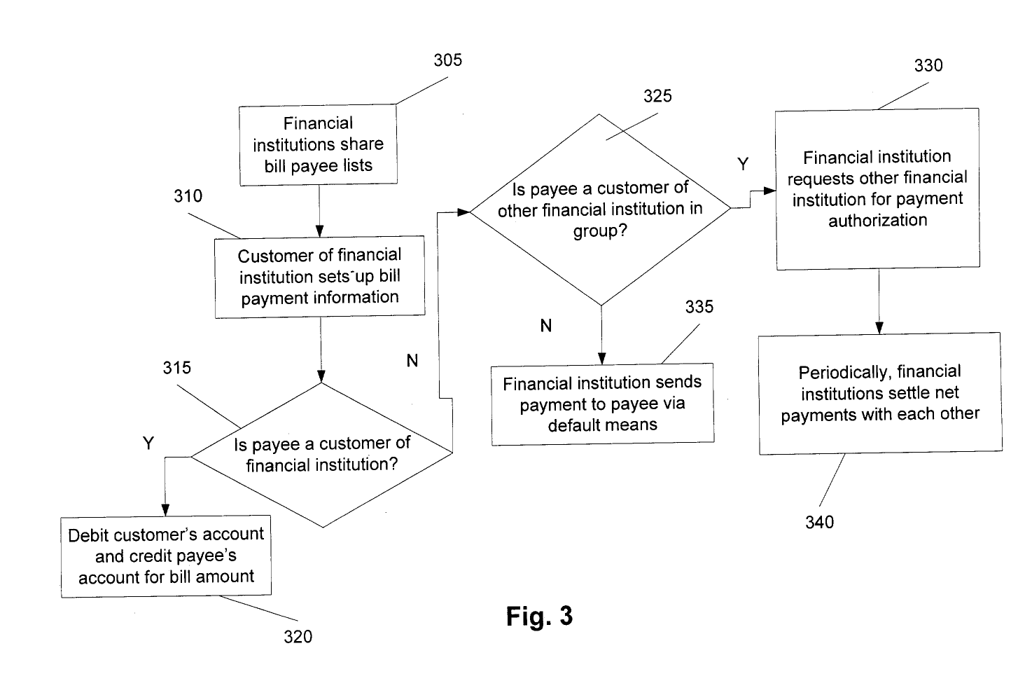

FIG. 2 illustrates a block diagram of bill payment architecture according to one embodiment of the invention. FIG. 2 illustrates a plurality of customers 105A-C of a plurality of corresponding financial institutions 110A-C paying bills owed to a plurality of payees 120A-C. FIG. 3 illustrates a flow diagram for paying bills according to one embodiment of the invention. As illustrated in FIGS. 2 and 3, at 305 a plurality of financial institutions exchange their bill payee lists. A bill payee list may be defined as a list comprising payee information including, the payee's name, address, the name of the financial institution at which the payee has an account, etc. In one embodiment of the invention, the exchange of bill payee lists between financial institutions may be done in a peer to peer manner. In a peer to peer exchange of bill payee lists, a first financial institution e.g., 110A sends its bill payee list, using a network 205, to a second financial institution e.g., 110B and the second financial institution 110B sends its bill payee list to a first financial institution 110A. Thus, each financial institution compiles a master bill payee list. In one embodiment of the invention, the second financial institution 110B may add its bill payee list to the bill payee list of financial institution 110A to form a master bill payee list and send the master bill payee list to financial institution 110A. In one embodiment of the invention, the first financial institution and the second financial institution are separate business entities and one may not be a subsidiary of the other.

In one embodiment of the invention, the exchange of payee lists between a plurality of financial institutions may be done using a hub and spoke model. In the hub and spoke model, financial institutions in the plurality of financial institutions send their bill payee list to a single financial institution or to an ASP (not shown). Thus, in the embodiment of FIG. 2 financial institutions 110B-C may send its bill payee list to financial institution 110A, or to the ASP that compiles each of the bill payee lists into a master bill payee list. The master bill payee list is then sent e.g., via a network to the plurality of financial institutions. The master bill payee list may be updated periodically e.g., daily, monthly, etc.

During setting up of the bill payment service, at 310 a customer of a financial institution, authenticates at (e.g., logs onto) the customer's financial institution's web-site, and either chooses a payee from a payee list provided by the financial institution, or designates a payee if the payee is not on the list provided. A financial institution may be defined as any institution that is financial in nature and includes an institution that at least provides financial services (e.g., checking and savings accounts) to the public. When designating a payee, the customer provides the financial institution (i.e., a first financial institution) with information on the bill e.g., the customers account number allocated to the customer by the payee, the payee's name, address, terms of payment, the amount owed on the bill, etc. Thus, the financial institution receives, via the network, for a customer bill payment information. In one embodiment of the invention, once the customer has identified a bill payee, the financial institution may receive a bill for the customer from the bill payee directly. In one embodiment of the invention, the customer may decide the manner in which the bill is to be paid. For example, the customer may choose to pay the bill via a wire to wire transfer of funds and provide the necessary information for the wire to wire transfer. The customer may choose to have the bill paid via a payment processor, and if a preferred method for payment of the bills is specified the financial information pays the bill in accordance with the method specified by the customer.

At 315, the first financial institution determines whether the payee is also a customer of the first financial institution. The first financial institution may determine this by searching the master bill payee list. If the first financial institution determines that the payee is also a customer of the first financial institution, at 320, the first financial institution debits the customer's account with at least the amount owed on the bill, and credits the payee's account for the amount owed the payee on the bill. However, if at 325 the first financial institution determines that the payee is a customer of a second financial institution listed on the master bill payee list, at 320 the first financial institution requests the second financial institution for a payment authorization. On receiving the payment authorization (e.g., a numeric or alphanumeric string representing an assent to the payment) from the second financial institution, the financial institution debits the account of its customer (i.e., debits at least the amount owed on the bill) and credits the account of the second financial institution. Payment authorization may cause a financial institution to follow one or more payee authorization rules with regards to depositing funds in a payee's account. For example, the payee authorization rules may include requiring that the payees information received is in a particular format, the maximum amount to be credited to the payees account is not exceeded, etc.

In one embodiment of the invention, the first financial institution does not request payment authorization from the second financial institution prior to debiting the account of its customer and crediting the payee's account of the second financial institution. In one embodiment of the invention, each payee in the master bill payee list may have associated with it one or more payee authorization rules. As stated above payee authorization rules may include e.g., requiring that the payees information received is in a particular format, the maximum amount to be credited to the payees account is not exceeded, etc. Each financial institution checks the payee authorization rules corresponding to the payee, complies with the payee authorization rules, then debits its customers account and credits the account of the second financial institution. Thus, the need to obtain authorization from a financial institution prior to sending payment owed on a bill is eliminated. In one embodiment of the invention, the payment authorization rules are sent by a financial institution to another as part of the bill payee list as described with respect to 305 above.

If at 325, the first financial institution determines that the payee is not on the master bill payee list, at 335 the first financial institution sends the bill payment to the payee via default means. Default means may include writing the bill payee a paper check and mailing it to the bill payee, or by sending the bill information to a payment processor for processing. The second financial institution follows the procedure illustrated above when processing the payments of its customer's bills. In one embodiment of the invention, the financial institutions process the bills (by following the method illustrated in FIG. 3) of its customers in real time i.e., as soon as instructed to do so by its customers. In one embodiment of the invention, the financial institutions process the bills of its customers in batch mode i.e., once a sufficient volume of bills have accumulated, or at a certain configurable time of day. Each financial institution may settle the net debt owed to the other financial institution via a periodic transfer of funds.

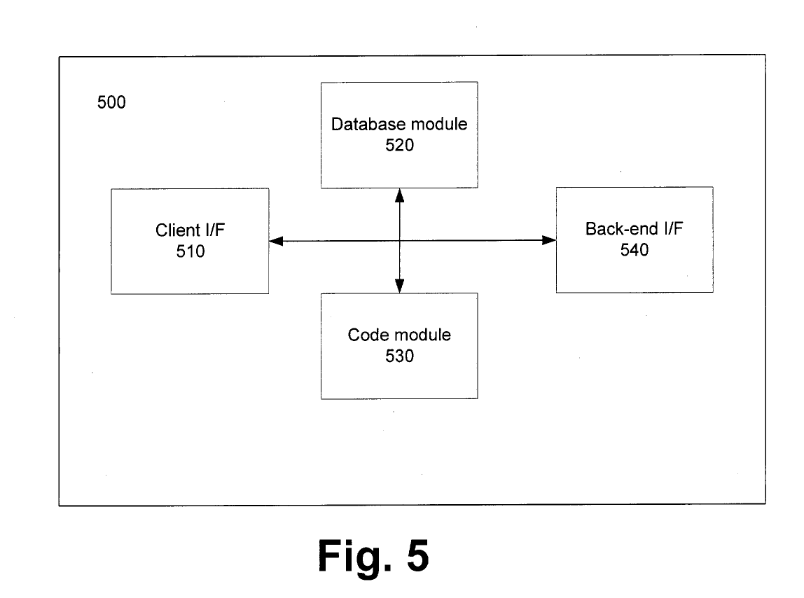

FIG. 5 illustrates a bill payment module according to one embodiment of the invention. As Illustrated in FIG. 5, the bill payment module 500 comprises a client interface 510, a Database module 520, a code module 530, and a back-end interface 540 coupled to each other as shown. The Client interface 510 interfaces with a client e.g., a customer of a financial institution. In particular, client interface 510 may interface with a customer's computer, PDA, wireless device, etc. Client interface 510 may also interface with the bill payment module of another financial institution or with an ASP. Client interface 510 may thus transmit and receive bill payee lists, including master bill payee lists, provide customers with a payee list during setting up of the bill payment service, receive payee information from customers or payees, send and/or receive a payment authorization request, etc.

Database module 520 coupled to code module 530, client interface 510 and to back-end interface 540 comprises one or more databases e.g., relational databases to store bill payee lists, including the master bill payee lists, bill payee information, payee authorization rules, payment authorizations, etc.

Code module 530 comprises the program code to execute the method illustrated in FIG. 3. For example, Code module 530 may retrieve a first financial institution's bill payee list from database module 520 and sends the retrieved information to client interface 510. Code module 530 may receive, e.g., a bill payee list from a different financial institution via client interface 510, or via back-end interface 540 and may store the information in database module 520. Code module 530 may store the bill payment information received from a customer of the financial institution, via client interface 510, in database module 520. Code module 530 may search database module 520 to determine whether a bill payee is a customer of the first financial institution and if so, credits the bill payee's account and debits the customer's account. If code module 530 determines that a bill payee is a customer of the second financial institution, the code module may request an authorization from the second financial institution as described above with respect to FIG. 3. In addition, code module 530 may execute one or more payee authorization rules, as described above, prior to crediting the account of the second financial institution and debiting the account of the customer that received the bill. In one embodiment of the invention, code module 530 may send bill information along with payment authorization to a payment processor if the bill payee is not on the bill payee lists stored in database module 520.

Back-end interface 540 coupled to database module 520, code module 530, and client interface 510 may send and/or receive payee and/or customer information from the financial institutions remote server. In one embodiment of the invention, back-end interface 540 may receive marketing information pertinent to the customer and send the information to client interface 510 for displaying on the customer's screen. The information may be displayed e.g., during the customer's bill payment set up process or when the customer logs on to the financial institution's web site to pay bills online.

In one embodiment of the invention, the financial institutions may implement the process illustrated in FIGS. 2, and 3 using a Secure Sockets Layer (SSL), or the Transport Layer Security (TLS) protocol (please see Internet Request for Comments (RFC) 3207 for more details). In one embodiment of the invention, the method illustrated in FIGS. 2, 3 and 4 are implemented using Simple Object Access Protocol (SOAP), eXtensible Markup Language (XML), and International Financial eXchange (IFX).

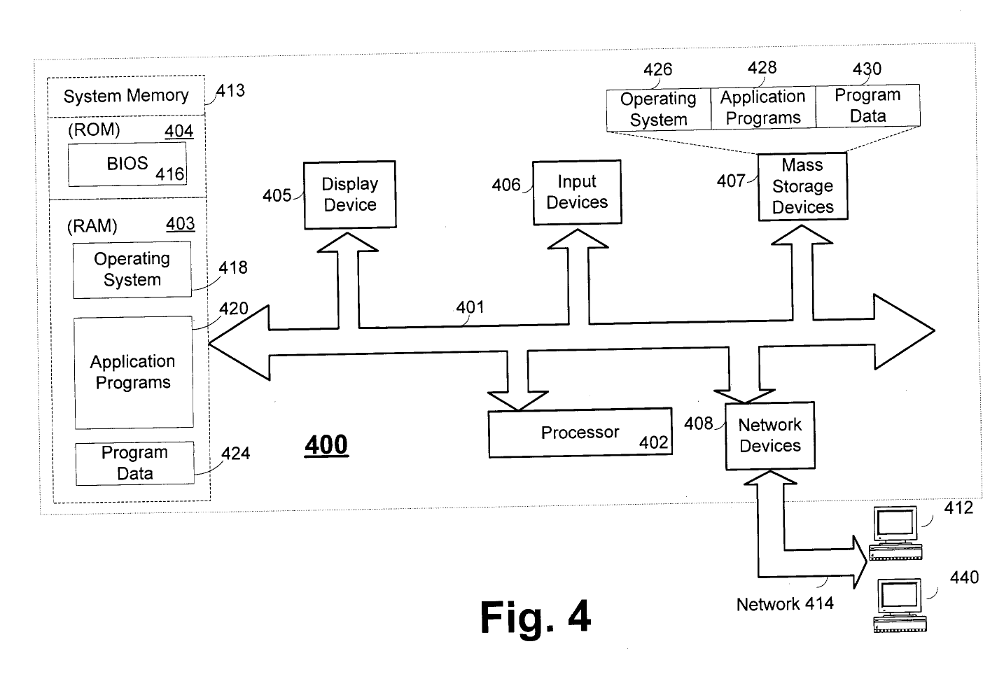

FIG. 4 illustrates an apparatus for paying bills online according to one embodiment of the invention. In general, the apparatus may comprise a computer system that includes a processor 402 coupled through a bus 401 to system memory 413 and a mass storage device 407.

System memory 413 comprises a read only memory (ROM) 404 and random access memory (RAM) 403. ROM 404 comprises basic input output system (BIOS) 416. RAM 403 comprises operating system 418, application programs 420, and program data 424. Application programs 420 include the program code (e.g., the code module 530 of FIG. 5) for implementing the method described with reference to FIGS. 2 and 3. Program data 424 may include e.g., customer sign-on data, and the master bill payee list. Mass storage device 407 represents a persistent data storage device, such as a floppy disk drive, fixed disk drive (e.g., magnetic, optical, magneto-optical, or the like), or streaming tape drive. Mass storage device 407 may store application programs 428 including, e.g., the program code to implement the bill payment method illustrated with respect to FIGS. 2 and 3. Mass storage device 407 may also store the operating system 426 for computer system 400, and program data 430. Processor 402 may be any of a wide variety of general purpose processors or microprocessors (such as the Pentium® processor family manufactured by Intel® Corporation), a special purpose processor, or a specifically programmed logic device.

Processor 402 is operable to receive instructions which, when executed by the processor cause the processor execute the bill payment method illustrated in FIGS. 2 and 3.

Display device 405 is coupled to processor 402 through bus 401 and provides graphical output for computer system 400. Input devices 406 such as a keyboard or mouse are coupled to bus 401 for communicating information and command selections to processor 402. Also coupled to processor 402 through bus 401 is an input/output interface (not shown) which can be used to control and transfer data to electronic devices (printers, other computers, etc.) connected to computer system 400. Computer system 400 includes network devices 408 for connecting computer system 400 to one or more networks 414. Network 414 may be communicatively coupled to an application service provider (ASP) 412, and to a host 440 e.g., a different financial institution. Network devices 408, may include Ethernet devices including network adapters, phone jacks and satellite links. It will be apparent to one of ordinary skill in the art that other network devices may also be utilized.

One embodiment of the invention may be stored entirely as a software product on mass storage 407. Another embodiment of the invention may be embedded in a hardware product, for example, in a printed circuit board, in a special purpose processor, or in a specifically programmed logic device communicatively coupled to bus 401. Thus, the program code may include instructions for paying bills online as illustrated with respect to FIGS. 2, and 3.

Thus, a method and apparatus have been disclosed for paying bills online. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method for paying bills online comprising:
sending by a first financial institution a first bill payee list to a second financial institution;
receiving a second bill payee list from the second financial institution;
receiving for a customer bill payment information including a bill payee;
searching the first and the second bill payee list to determine if the bill payee is on at least one of the first bill payee list and the second bill payee list; and
debiting the customer's account at least an amount owed on the bill if the bill payee is on at least one of the first bill payee list and the second bill payee list.

2. The method of claim 1 wherein debiting the customer's account at least the amount owed on the bill if the bill payee is on at least one of the first bill payee list and the second bill payee list comprises:
debiting the customer's account at least the amount owed on the bill if the bill payee is on the first bill payee list and crediting the bill payee's account with the amount owed on the bill.

3. The method of claim 1 wherein debiting the customer's account at least the amount owed on the bill if the bill payee is on at least one of the first bill payee list and the second bill payee list comprises:
requesting an authorization from the second financial institution; and
debiting the customer's account at least the amount owed on the bill and sending the amount owed on the bill to the second financial institution.

4. The method of claim 1 further comprising at least one of sending the second financial institution a net payment and receiving from the second financial institution a net payment.

5. The method of claim 1 wherein receiving a second bill payee list from the second financial institution comprises receiving a master bill payee list said master bill payee list comprising the first bill payee list and the second bill payee list.

6. The method of claim 1 further comprising debiting the customer's account if the bill payee is not on at least one of the first bill payee list and the second bill payee list, and any one of sending a check to the bill payee and sending the amount owed on the bill to a payment processor.

7. A method for paying bills online comprising:
exchanging bill payee lists between a plurality of financial institutions to form a master bill payee list;
receiving by a financial institution in the plurality of financial institutions the master bill payee list;
receiving by the financial institution from a customer of the financial institution bill payment information including a bill payee;
searching by the financial institution the master bill payee list to determine if the bill payee is on the master bill payee list; and
debiting the customer's account, by the financial institution, at least an amount owed on the bill if the bill payee is on the master bill payee list.

8. The method of claim 7, wherein exchanging bill payee lists between a plurality of financial institutions to form a master bill payee list comprises, each financial institution in the plurality of financial institutions sending their bill payee lists to an application service provider to generate the master bill payee list.

9. The method of claim 7 wherein debiting the customer's account, by the financial institution, at least the amount owed on the bill if the bill payee is on the master bill payee list comprises the financial institution debiting the customer's account at least the amount owed on the bill, and crediting the bill payees account the amount owed on the bill if the bill payee is also a customer of the financial institution.

10. The method of claim 7 wherein debiting the customer's account, by the financial institution, at least an amount owed on the bill if the bill payee is on the master bill payee list comprises:
determining by the financial institution that the bill payee is a customer of another financial institution;
requesting an authorization from the other financial institution to pay the amount owed on the bill;
debiting the customer's account at least the amount owed on the bill; and
sending the amount owed on the bill to the other financial institution.

11. The method of claim 10, wherein the other financial institution credits the bill payee's account and sends the bill payee an invoice number of the bill.

12. The method of claim 7 wherein exchanging bill payee lists between a plurality of financial institutions to form a master bill payee list comprises the plurality of financial institutions exchanging bill payee names and bill payee payment authorization rules.

13. An apparatus comprising:
a network device to send a first bill payee list to a second financial institution, to receive a second bill payee list from the second financial institution, and to receive from a customer bill payment information, said bill payment information including a bill payee;
a processor coupled to the network device to search the first and the second bill payee list to determine if the bill payee is on at least one of the first bill payee list and the second bill payee list, and said processor to debit the customer's account at least an amount owed on the bill if the bill payee is on at least one of the first bill payee list and the second bill payee list.

14. The apparatus of claim 13 wherein the processor to debit the customer's account at least the amount owed on the bill if the bill payee is on at least one of the first bill payee list and the second bill payee list comprises the processor to debit the customer's account at least the amount owed on the bill if the bill payee is on the first bill payee list, and the processor to credit the bill payee's account with an amount owed on the bill.

15. The apparatus of claim 13 wherein the processor to debit the customer's account at least the amount owed on the bill if the bill payee is on at least one of the first bill payee list and the second bill payee list comprises the processor to request an authorization from the second financial institution to pay an amount owed on the bill, and the processor to debit the customer's account at least an amount owed on the bill and to send the amount owed on the bill to the second financial institution.

16. An article of manufacture comprising:
a machine-accessible medium including instructions that, when executed by a machine, causes the machine to perform operations comprising
sending by a first financial institution a first bill payee list to a second financial institution;
receiving a second bill payee list from the second financial institution;
receiving for a customer bill payment information including a bill payee;
searching the first and the second bill payee list to determine if the bill payee is on at least one of the first bill payee list and the second bill payee list; and
debiting the customer's account at least an amount owed on the bill if the bill payee is on at least one of the first bill payee list and the second bill payee list.

17. An article of manufacture as in claim 16, wherein said instructions for debiting the customer's account at least the amount owed on the bill if the bill payee is on at least one of the first bill payee list and the second bill payee list comprises further instructions for debiting the customer's account at least the amount owed on the bill if the bill payee is on the first bill payee list and crediting the bill payee's account with the amount owed on the bill.

18. An article of manufacture as in claim 16, wherein said instructions for debiting the customer's account at least the amount owed on the bill if the bill payee is on at least one of the first bill payee list and the second bill payee list comprises further instructions for requesting an authorization from the second financial institution, and debiting the customer's account at least the amount owed on the bill and sending the amount owed on the bill to the second financial institution.

19. An article of manufacture as in claim 16, wherein said instructions include further instructions for at least one of, sending the second financial institution a net payment and receiving from the second financial institution a net payment.
